(19) United States
(12) Patent Application Publication
(10) Pub. No.: US 2019/0130918 A1
(43) Pub. Date: May 2, 2019

(54) VOICEPRINT AUTHENTICATION METHOD BASED ON DEEP LEARNING AND TERMINAL

(71) Applicant: BAIDU ONLINE NETWORK TECHNOLOGY (BEIJING) CO., LTD., Beijing (CN)

(72) Inventors: Bengu WU, Beijing (CN); Chao LI, Beijing (CN); Yong GUAN, Beijing (CN)

(21) Appl. No.: 16/096,049

(22) PCT Filed: Sep. 5, 2016
(86) PCT No.: PCT/CN2016/098127

§ 371 Date: Oct. 24, 2018

(30) Foreign Application Priority Data
May 25, 2016 (CN) 201610353878.2

(51) Int. Cl. G10L 17/02

(52) U.S. Cl. CPC G10L 17/02

(57) ABSTRACT

The present disclosure provides a voiceprint authentication method based on deep learning, a terminal and a non-transitory computer readable storage medium. The method includes: receiving a voice from a speaker; extracting a d-vector feature of the voice; obtaining a determined d-vector feature of the speaker during a registration stage; calculating a matching value between the d-vector feature and the determined d-vector feature; and determining that the speaker passes authentication when the matching value is greater than or equal to a threshold.

### CROSS REFERENCE TO RELATED APPLICATION

This application claims priority to Chinese Patent Application No. 201610353878.2, filed with the State Intellectual Property Office of P. R. China on May 25, 2016, by BAIDU ONLINE NETWORK TECHNOLOGY (BEIJING) CO., LTD. and titled with “Deep Learning-Based Voiceprint Authentication Method and Device”.

### TECHNICAL FIELD

The present disclosure relates to the field of voice processing technologies, and more particular to a voiceprint authentication method based on deep learning and a voiceprint authentication device based on deep learning.

### BACKGROUND

Deep learning originates from study of artificial neural networks. A multilayer perceptron with multiple hidden layers is a deep learning structure. With the deep learning, low-level features are combined to form a more abstract high-level representing attribute categories or features, to discover distributed feature representations of data. The deep learning is a new field in machine learning research. The motivation is to build a neural network that simulates the human brain for analytical learning. It mimics the mechanism of the human brain to interpret data such as images, sounds and texts. Voiceprint authentication refers to the identity authentication of a speaker based on the voiceprint features in the voice from a speaker.

### SUMMARY

A voiceprint authentication method based on deep learning according to embodiments of the present disclosure includes: receiving a voice from a speaker; extracting a d-vector feature of the voice; acquiring a determined d-vector feature of the speaker during a registration stage; calculating a matching value between the d-vector feature and the determined d-vector feature; and when the matching value is greater than or equal to a threshold, determining that the speaker passes authentication.

A terminal according to embodiments of the present disclosure includes one or more processors; a memory; and one or more programs, stored in the memory, in which when the one or more programs are executed by the one or more processors, the one or more processors are configured to: receive a voice from a speaker; extract a d-vector feature of the voice; acquire a determined d-vector feature of the speaker during a registration stage; calculate a matching value between the d-vector feature and the determined d-vector feature; and when the matching value is greater than or equal to a threshold, determine that the speaker passes authentication.

A non-transitory computer readable storage medium according to embodiments of the present disclosure is configured to store an application. The application is configured to execute the voiceprint authentication method based on deep learning according to any one of embodiments described above.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above and additional aspects and advantages of embodiments of the present disclosure will become apparent and more readily appreciated from the following descriptions made with reference to the drawings, in which:

FIG. 1 is a flow chart illustrating a voiceprint authentication method based on deep learning according to an embodiment of the present disclosure;

FIG. 2 is a schematic diagram illustrating a DNN used in embodiments the present disclosure;

FIG. 3 is a flow chart illustrating a registration stage according to embodiments of the present disclosure;

FIG. 4 is a block diagram illustrating a voiceprint authentication device based on deep learning according to an embodiment of the present disclosure; and

FIG. 5 is a block diagram illustrating a voiceprint authentication device based on deep learning according to an embodiment of the present disclosure.

### DETAILED DESCRIPTION

Descriptions will be made in detail to embodiments of the present disclosure. Examples of embodiments described are illustrated in drawings. The same or similar elements and the elements having same or similar functions are denoted by like reference numerals throughout the descriptions. The embodiments described herein with reference to drawings are explanatory, and used to explain the present disclosure and are not construed to limit the present disclosure.

In related arts, voiceprint authentication is generally performed based on a Mel Frequency Cepstrum Coefficient (MFCC) or a Perceptual Linear Predictive (PLP) feature, and a Gaussian Mixture Model (GMM). A voiceprint authentication effect in the related arts needs to be improved.

Therefore, embodiments of the present disclosure provide a voiceprint authentication method based on deep learning, a terminal and a non-transitory computer readable storage medium.

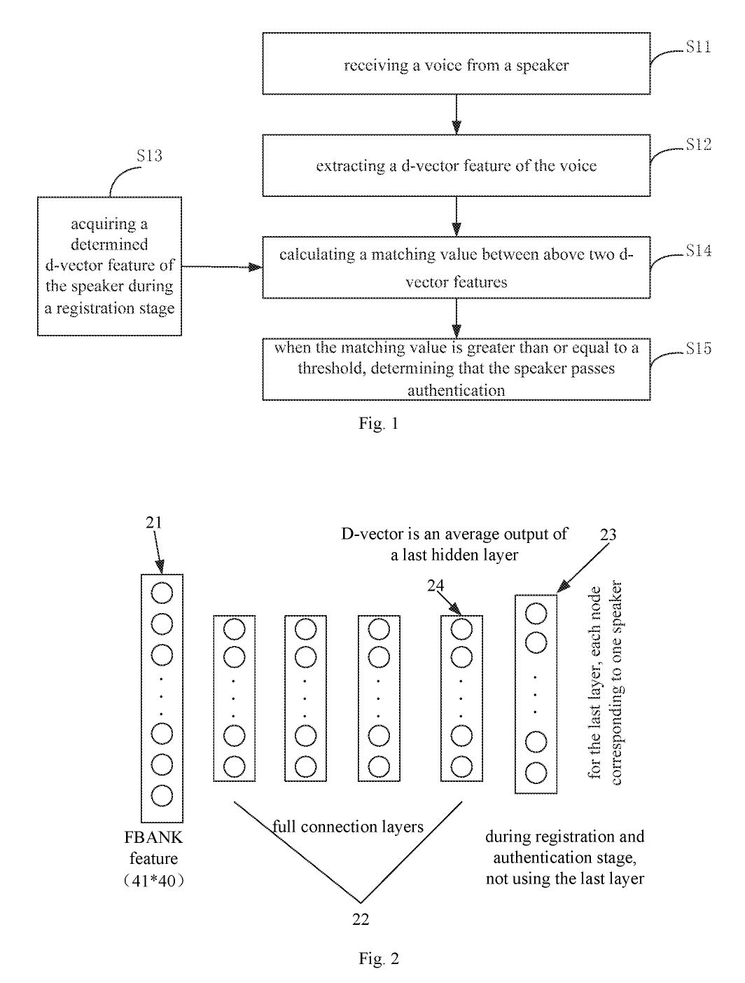

FIG. 1 is a flow chart illustrating a voiceprint authentication method based on deep learning according to an embodiment of the present disclosure.

As illustrated in FIG. 1, the voiceprint authentication method according to embodiments includes the following.

In block S11, a voice is received from a speaker.

The authentication may be text-related or text-unrelated. When the authentication is text-related, corresponding voice is provided from the speaker according to a prompt or a fixed content. When the authentication is text-unrelated, the voice is not limited.

In block S12, a d-vector feature of the voice is extracted.

The d-vector feature is a kind of feature extracted through a deep neural network (DNN), specifically being an output of a last hidden layer of DNN.

The schematic diagram of the DNN may be illustrated in FIG. 2. As illustrated in FIG. 2, the DNN includes an input layer 21, hidden layers 22 and an output layer 23.

The input layer is configured to receive an input feature extracted from the voice, for example 41*40 sized FBANK feature. The number of nodes of the output layer is same with the number of speakers. Each node corresponds to one speaker. The number of hidden layers may be set. The DNN may adopt a full connection manner, for example.

The FBANK feature is that the output of a Mel filter in the digital field is an acoustic feature, i.e., Filter-bank feature.

As illustrated in FIG. 2, when it is required to extract the d-vector feature of the voice, the FBANK feature of the voice may be extracted, and the FBANK feature may be inputted to the input layer of the DNN, through a parameter-determined-DNN (determined via model training), the output 24 of the last hidden layer may be obtained. The output is determined as the d-vector feature. It may be seen from the flow chart, when the d-vector feature of the voice is determined, the output layer of the DNN is not required. However, when the model is trained, the output layer is used, and the input layer and the hidden layers are also used.

In block S13, a determined d-vector feature of the speaker during a registration stage is acquired.

During an authentication stage, an identity identifier of the speaker may also be acquired. During the registration stage, the identity identifier and the d-vector feature may be stored correspondingly, such that the determined d-vector feature during the registration stage may be acquired according to the identity identifier.

Before the authentication stage, the registration is done.

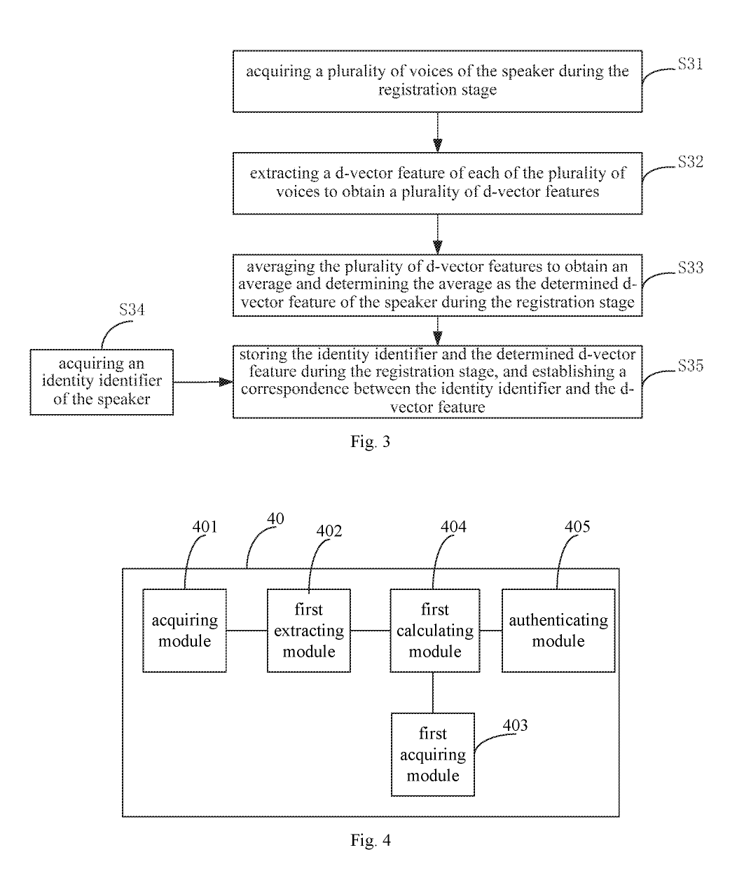

As illustrated in FIG. 3, the registration process of the speaker may include the following.

In block S31, a plurality of voices provided by the speaker during the registration stage are acquired.

For example, during the registration stage, each speaker may provide a plurality of voices. The plurality of voices may be received by a client and sent to a server for processing.

In block S32, a d-vector feature of each of the plurality of voices is acquired, to obtain a plurality of d-vector features.

After the server receives the plurality of voices, for each of the plurality of voices, the d-vector feature of the voice may be extracted. Therefore, when there are the plurality of voices, there are the plurality of d-vector features.

When the server extracts the d-vector feature of the voice, the DNN (specifically not using the last output layer) illustrated in FIG. 2 may be used to perform the extraction. Details may refer to above descriptions, which are not elaborated herein.

In block S33, the plurality of d-vectors are averaged to determine an average. The average is determined as the determined d-vector feature of the speaker during the registration stage.

Further, the registration process may further include the following.

In block S34, the identity identifier of the speaker is acquired.

For example, the speaker may input the identity identifier, such as an account, when registering.

In block S35, the identity identifier and the determined d-vector feature during the registration stage are stored, and a correspondence between the identity identifier and the determined d-vector is established.

For example, the identity identifier of the speaker is ID1, and the average of the d-vector after the calculation is d-vector-avg. The D1 and the d-vector-avg may be stored, and the correspondence between the ID1 and the d-vector-avg is established.

In block S14, a matching value between above two d-vector features is calculated. For example, the d-vector feature extracted during the authentication stage is denoted by d-vector1 while the determined d-vector feature during the registration stage, such as the average, is denoted by d-vector 2. The matching value between the d-vector 1 and the d-vector 2 may be calculated.

Since both of the d-vector1 and the d-vector2 are vectors, a calculation method for calculating the matching degree between vectors may be adopted. For example, cosine distance, or a linear discriminant analysis (LDA) may be adopted.

In block S15, when the matching value is greater than or equal to a threshold, it is determined that the speaker passes authentication.

On the other hand, when the matching value is less than the threshold, it is determined that the speaker does not pass authentication.

In embodiments, the voiceprint authentication is performed based on the d-vector feature. Since the d-vector feature is acquired via the DNN network, compared with the GMM model, more effective voiceprint features may be acquired, thereby improving a voiceprint authentication effect.

FIG. 4 is a block diagram illustrating a voiceprint authentication device based on deep learning according to an embodiment of the present disclosure.

As illustrated in FIG. 4, the device 40 according to embodiments includes a receiving module 401, a first extracting module 402, a first acquiring module 403, a first calculating module 404 and an authenticating module 405.

The receiving module 401 is configured to receive a voice of a speaker.

The first extracting module 402 is configured to extract a d-vector feature of the voice.

The first acquiring module 403 is configured to acquire a determined d-vector feature of the speaker during a registration stage.

The first calculating module 404 is configured to calculate a matching value between above two d-vector features.

The authenticating module 405 is configured to determine that the speaker passes authentication when the matching value is greater than or equal to a threshold.

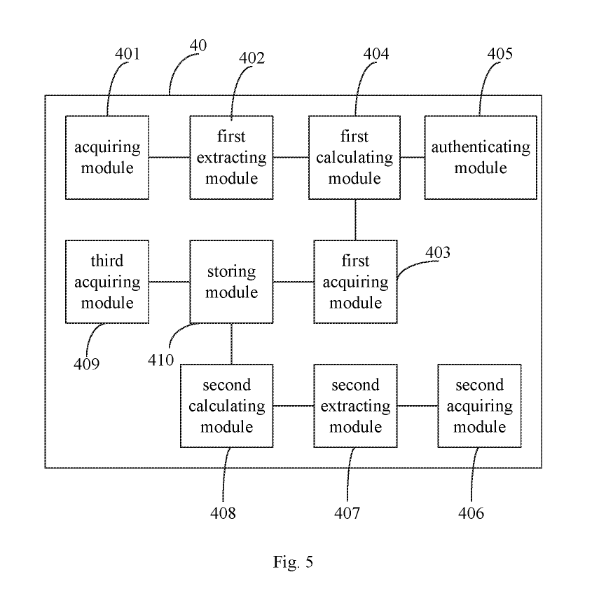

In some embodiments, as illustrated in FIG. 5, the device 40 further includes the following.

A second acquiring module 406 is configured to acquire a plurality of voices of the speaker during the registration stage.

A second extracting module 407 is configured to extract a d-vector feature of each of the plurality of voices to obtain a plurality of d-vector features.

A second calculating module 408 is configured to average the plurality of d-vector features to obtain an average and determine the average as the determined d-vector feature of the speaker during the registration stage.

In some embodiments, as illustrated in FIG. 5, the device 40 further includes the following.

A third acquiring module 409 is configured to acquire an identity identifier of the speaker during the registration stage.

A storing module 410 is configured to store the identity identifier and the determined d-vector feature during the registration stage, and establish a correspondence between the identity identifier and the determined d-vector feature.

In some embodiments, the first acquiring module 403 is specifically configured to:

acquire the identity identifier of the speaker after the voice is received from the speaker; and

acquire the d-vector feature corresponding to the identity identifier according to the correspondence.

In some embodiments, the first extracting module 402 is specifically configured to:

extract an input feature of the voice; and

obtain an output of a last hidden layer of the DNN using a pre-determined DNN and the input feature, and determine the output as the d-vector feature.

In some embodiments, the input feature includes FBANK feature.

It may be understood that, the device according to embodiments corresponds to the method according to embodiments. Details may refer to related descriptions, which are not described in detail herein.

In embodiments, the voiceprint authentication is performed based on the d-vector feature. Since the d-vector feature is obtained through the DNN network, compared with the GMM mode, more effective voiceprint features may be obtained, thereby improving a voiceprint authentication effect.

In order to implement the above embodiments, the present disclosure further provides a terminal, including one or more processors; a memory; and one or more programs stored in the memory. When the one or more programs are executed by the one or more processors, the following are executed.

In block 511′, a voice is received from a speaker.

In block S12′, a d-vector feature of the voice is extracted.

In block S13′, the d-vector feature of the speaker during a registration stage is acquired.

In block S14′, a matching value between above two d-vector features is calculated.

In block S15′, when the matching value is greater than or equal to a threshold, it is determined that the speaker passes authentication.

In order to implement the above embodiments, the present disclosure further provides a storage medium. The storage medium may be configured to store an application. The application is configured to execute the method for authenticating a voiceprint based on deep learning according to any one of embodiments described above.

It should be explained that, in the description of the present disclosure, terms such as “first” and “second” are used herein for purposes of description and are not intended to indicate or imply relative importance or significance. In addition, in the description of the present disclosure, “a plurality of” refers to at least two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, including executing functions in a substantially simultaneous manner or in an opposite order according to the related functions, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

In the description of the present disclosure, terms such as “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

Although explanatory embodiments have been illustrated and described, it would be appreciated by those skilled in the art that the above embodiments are exemplary and cannot be construed to limit the present disclosure, and changes, modifications, alternatives and varieties can be made in the embodiments by those skilled in the art without departing from scope of the present disclosure.

1. A voiceprint authentication method based on deep learning, comprising:
receiving a voice from a speaker;
extracting a d-vector feature of the voice;
acquiring a determined d-vector feature of the speaker during a registration stage;
calculating a matching value between the d vector feature and the determined d-vector feature; and
when the matching value is greater than or equal to a threshold, determining that the speaker passes authentication.

2. The method according to claim 1, further comprising:
acquiring a plurality of voices of the speaker during the registration stage;
extracting a d-vector feature of each of the plurality of voices to obtain a plurality of d-vector features; and
averaging the plurality of d-vector features to obtain an average and determining the average as the determined d-vector feature of the speaker during the registration stage.

3. The method according to claim 2, further comprising:
during the registration stage, acquiring an identity identifier of the speaker; and
storing the identity identifier and the determined d-vector feature during the registration stage, and establishing a correspondence between the identity identifier and the determined d-vector feature.

4. The method according to claim 3, wherein acquiring the determined d-vector feature of the speaker during the registration stage comprises:
after receiving the voice from the speaker, acquiring the identity identifier of the speaker; and
acquiring the determined d-vector feature corresponding to the identity identifier according to the correspondence.

5. The method according to claim 1, wherein extracting the d-vector feature comprises:
extracting an input feature of the voice;
inputting the input feature of the voice to an input layer of a pre-determined deep neural network (DNN); and
obtaining an output of a last hidden layer of the pre-determined DNN as the d-vector feature.

6. The method according to claim 5, wherein the input feature comprises:
FBANK feature.

7. -12. (canceled)

13. A terminal, comprising
one or more processors;
a memory; and
one or more programs, stored in the memory, wherein when the one or more programs are executed by the one or more processors, the one or more processors are configured to:
receive a voice from a speaker;
extract a d-vector feature of the voice;
acquire a determined d-vector feature of the speaker during a registration stage;
calculate a matching value between the d-vector feature and the determined d-vector feature; and
when the matching value is greater than or equal to a threshold, determine that the speaker passes authentication.

14. A non-transitory computer readable storage medium, comprising an application, wherein the application is configured to:
receive a voice from a speaker;
extract a d-vector feature of the voice;
acquire a determined d-vector feature of the speaker during a registration stage;
calculate a matching value between the d-vector feature and the determined d-vector feature; and
when the matching value is greater than or equal to a threshold, determine that the speaker passes authentication.

15. The method according to claim 1, wherein the matching value is obtained via a cosine distance method or a linear discriminant analysis (LDA) method.

16. The terminal according to claim 13, wherein the one or more processors are further configured to:
acquire a plurality of voices of the speaker during the registration stage;
extract a d-vector feature of each of the plurality of voices to obtain a plurality of d-vector features; and
average the plurality of d-vector features to obtain an average and determine the average as the determined d-vector feature of the speaker during the registration stage.

17. The terminal according to claim 16, wherein the one or more processors are further configured to:
acquire an identity identifier of the speaker during the registration stage; and
store the identity identifier and the determined d-vector feature during the registration stage, and establish a correspondence between the identity identifier and the determined d-vector feature.

18. The terminal according to claim 17, wherein the one or more processors are configured to acquire the determined d-vector feature of the speaker during the registration stage by acts of:
after receiving the voice from the speaker, acquiring the identity identifier of the speaker; and
acquiring the determined d-vector feature corresponding to the identity identifier according to the correspondence.

19. The terminal according to claim 13, wherein the one or more processors are configured to extract the d-vector feature by acts of:
extracting an input feature of the voice;
inputting the input feature of the voice to an input layer of a pre-determined deep neural network (DNN); and
obtaining an output of a last hidden layer of the pre-determined DNN as the d-vector feature.

20. The terminal according to claim 19, wherein the input feature comprises:
FBANK feature.

21. The terminal according to claim 13, wherein the matching value is obtained via a cosine distance method or a linear discriminant analysis (LDA) method.

22. The non-transitory computer readable storage medium according to claim 14, wherein the application is further configured to:
acquire a plurality of voices of the speaker during the registration stage;
extract a d-vector feature of each of the plurality of voices to obtain a plurality of d-vector features; and
average the plurality of d-vector features to obtain an average and determine the average as the determined d-vector feature of the speaker during the registration stage.

23. The non-transitory computer readable storage medium according to claim 22, wherein the application is further configured to:
acquire an identity identifier of the speaker during the registration stage; and
store the identity identifier and the determined d-vector feature during the registration stage, and establish a correspondence between the identity identifier and the determined d-vector feature.

24. The non-transitory computer readable storage medium according to claim 23, wherein the application is configured to acquire the determined d-vector feature of the speaker during the registration stage by acts of:
after receiving the voice from the speaker, acquiring the identity identifier of the speaker; and
acquiring the determined d-vector feature corresponding to the identity identifier according to the correspondence.

25. The non-transitory computer readable storage medium according to claim 14, wherein the application is configured to extract the d-vector feature by acts of:
extracting an input feature of the voice;
inputting the input feature of the voice to an input layer of a pre-determined deep neural network (DNN); and
obtaining an output of a last hidden layer of the pre-determined DNN as the d-vector feature.

26. The non-transitory computer readable storage medium according to claim 25, wherein the input feature comprises:
FBANK feature.
